(19) United States
(12) Patent Application Publication
(10) Pub. No.: US 2004/0211096 A1
(43) Pub. Date: Oct. 28, 2004

(54) Tree spade soil retainer

(76) Inventor: Thomas Michael Kewan, Eau Claire, WI (US)

Correspondence Address: THOMAS M. KEWAN, 4810 RIVERCREST DRIVE, EAU CLAIRE, WI, 54703, US

(21) Appl. No.: 10/426,128

(22) Filed: Apr. 28, 2003

(51) Int. Cl. A01B 13/00

(52) U.S. Cl. 37/302

(57) ABSTRACT

An apparatus (10) for keeping root-balled trees and soil bonded together while transporting the like within a tree spade, by encompassing in a retainer shell (11) the complete ground digging portion of the blades of a tree spade, further including a removable bottom lid (13) as means to seal the remaining bottom opening (20) which coincides with the open bottom digging portion of a tree spades extended blades (32). A plurality of couplers (17) are mounted for pivotal movement on lift tabs (12) which allow for coupling and uncoupling the entire apparatus (10) to a tree spade (30).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

This invention relates to a tree spade soil retainer, when coupled to a corresponding sized tree spade allows control over the root-ball and soil within it.

### BACKGROUND OF THE INVENTION

Landscaping projects often require that trees and plants be moved. For larger trees and plants, the transplanting process will often be accomplished with a hydraulic tree spade. These tree spades vary both in size and shape. The general rule is, the larger the diameter tree, the larger spade that is needed. Certain types of soil also differentiate that certain tree spade configurations and digging methods be used.

Tree spades used in loose soils typically have blades that come together to form a tight point at the bottom. This tight point helps retain any soil that might fall away from a root-ball being transported. These V-shaped tree spades have long, steeply angled blades.

The V-shaped spades can be used in a wide variety of soils. Its V-shape results in a root ball that is very long and narrow for its weight. Because of the steep cutting angle of its blades many secondary roots are left behind. This is a significant disadvantage.

In heavy, compacted soils, a tree spade with less-angle in the blades is often used. Their blades are manufactured to dig into the ground at a more vertical angle. Hence a wider root ball is obtained. With a wider root-ball, more secondary roots are captured. Their blades are also shorter. They do not dig as deep as a V-shaped tree spade. With a shorter root-ball, there is less weight to handle. This type of tree spade will capture the most roots in the least soil. The result is a dense, lightweight root-ball with a flat bottom. That makes this style of root-balled tree much more desirable and transportable. These open-bottom tree spades are often referred to as truncated spades.

Unfortunately, due to their physical configuration, truncated spades can loose dirt out of their open bottoms. Soil leakage mainly occurs while transporting soil with a truncated tree spade. This is especially true in sandy soil. The more travel, the more soil that is lost from the spade. The less soil that is retained attached to the root-ball while in the tree spade, the less chance for the plants survival. The need to effectively contain soil on-site while performing initial tree spade work is critical. Soil retention is critical to the success of extended root-ball transport. Several popular inventions for extended root-ball transport are listed below that show the need for a tree spade soil container.

For example, U.S. Pat. No. 5,311,700 to Thomas shows spaded root-balls being placed into wire baskets that are lined with burlap. The process involves an inventory of wire baskets of various sizes that are typically filled with a truncated tree spade. Although a wire basket can be filled right next to where a tree was removed, this is not the practice. More often the spaded tree is brought to a centralized, on-site, tying location. Carrying a root-ball with a truncated spade even a short distance to a centralized tying location can result in massive soil loss out of the open bottom of the spade. This reduces the plants survivability. The use of the tree spade soil retainer would significantly enhance the Thomas invention and other burlap lined wire basket systems.

Tree spade transport receptacles attached to single-purpose trailers are popular. For example, in U.S. Pat. No. 4,709,955 Peters et al. shows how spaded root-balls are transported on a trailer. The operator of a truncated open-bottom tree spade could loose a great deal of soil transporting root-balls to and from a trailer that was stationed away from the digging operation. Loading or unloading this style receptacle requires moving the entire trailer close to the work site. This makes planting with a truncated tree spade in close quarters impossible. This is especially true in urban lots that have numerous obstacles. Damage done to a lawn from a heavy-loaded trailer is also possible. Use of the tree spade soil retainer invention would make this method much more effective.

U.S. Pat. No. 3,782,773 to Mason shows in FIG. 2 a specialty trailer with detachable receptacles. Note that this receptacle does not couple directly to a tree spade. As stated on Page 3, additional equipment, not adapted for use with a tree spade, such as a crane or fork lift is required to move the receptacle. Using this type of equipment usually results in extra cost, lost time and more damage to a lawn. Note that the receptacle shown in this invention is deficient in that it is not easy to move and has no removable bottom lid. There is no easy way of empting residual soil out of these receptacles other than tipping them over or disassembling them. Emptying soil this way is extremely difficult, time consuming and problematic. The tree spade soil retainer invention has a removable bottom for easily removing residual soil and transporting without the need for additional equipment. Both these features overcome the deficiencies found in this prior art.

U.S. Pat. No. 4,796,941 to Reilly shows in FIG. 7 a single-standing tree spade receptacle used in conjunction with the loading of a tree transport trailer. The single-standing receptacle shown includes a plurality of uprights and wide base to support it. Unlike the tree spade soil retainer, Reilly's receptacle, as stated on Page 4, is heavily constructed to allow the retracted blades of a tree spade to literally plunge down into a full container and extract a transplant. In contrast, the tree spade soil retainer was designed to contain transplants already being within the fully extended blades of a tree spade. This eliminates the need for the plurality of uprights and the wide base. The tree spade soil retainer is thereby lighter and can be physically moved about on the ground by one person. This allows an operator to manually line up the soil retainer with a tree spade in contrast to maneuvering heavy equipment around it. The more one maneuvers heavy equipment, the more damage that is done to lawns and properties.

Like Mason's U.S. Pat. No. 3,782,773, Reilly's invention also lacks a removable bottom lid to empty left-over soil from it. The receptacle must be shoveled out or tipped over in order to be completely emptied. Here again, the tree spade soil retainer invention overcomes these deficiencies.

There is a need for increased root-ball and soil retention that prior art has not addressed. The retention need is before tree spaded root-balls and soil are placed into other transportation devices. More specifically, there is a need for a diaper-like device that keeps the soil within in a truncated spade while being transported to a waiting trailer receptacle or burlap lined wire basket.

In light soils operators have been restricted to V-shaped tree spades. Sometimes operators of truncated spades have been forced to keep the whole transplanting process within a few measured feet. A device is needed to . . . eliminate soil from falling out of truncated spades; allow for easy disposal of residual soil; allow for precise delivery of all residual soil back to a related hole in the ground left over from the tree spade removal process; allow operators to work effectively in light soils.

### BACKGROUND OF THE INVENTION —OBJECTS AND ADVANTAGES

Accordingly, besides the objects and advantages of the tree spade soil retainer described in my patent above, several other objects and advantages of the present Patent Application of Thomas M. Kewan for the “Tree-Spade Soil Retainer” invention are:

a to provide a portable soil retainer that is easily coupled and uncoupled directly to a tree spade;

b. to provide a retainer that seals in transplanting soil, eliminating messy spilled soil that often drops out of open-bottom tree spades;

c. to provide a retainer that allows for easy removal of residual soil after each use through a removable bottom member.

d. to provide a retainer that allows for the placement of residual soil precisely where desired;

e. to provide a way to effectively use the open-bottom truncated type spades in light soils;

f. to provide a method to move retainers with the tree spade itself that does require separate equipment;

g. to provide a way to avoid the use of heavy trailers that can damage lawns;

h. to provide a light weight retainer that can be positioned under a tree spade by one person.

Further objects and advantages are, the tree spade soil retainer is simple to use. It also obviates the need to own different types of tree spades for varying degrees of soil density. It can be used in combination with other transportation devices to extended locations. This soil retainer multiplies the situations where a truncated spade can be effectively used. Other objects and advantages will become apparent from the drawings and the specifications.

### SUMMARY

The present invention comprises a soil retainer apparatus which overcomes the difficulty of keeping root-balls and soil bundled together when using a truncated tree spade. This difficulty is greatest in loose soil. The present invention enables one to place more of the original-spaded soil into burlap-lined wire baskets, transport trailer receptacles or into a waiting hole.

It is also an object of the present invention to provide a novel retainer that can be easily coupled to a tree spade. The retainer also allows for easy and precise evacuation of any residual soil that would remain in the retainer after use.

### DRAWINGS—FIGURES

FIG. 1 is a perspective of the tree spade soil retainer positioned to link to a typical tree spade;

FIG. 2 is an exploded view of the retainer showing all detachable parts removed.

### DRAWINGS—REFERENCE NUMERALS

10 apparatus

11 retainer shell

12 lift tab

13 bottom lid

14 bottom guide

15 guide peg

16 guide peg safety clip

17 coupler

18 pin

19 retainer top opening

20 retainer bottom opening

30 tree spade (prior art)

32 tree spade blade (prior art)

40 tree root ball (prior art)

50 transplant (prior art)

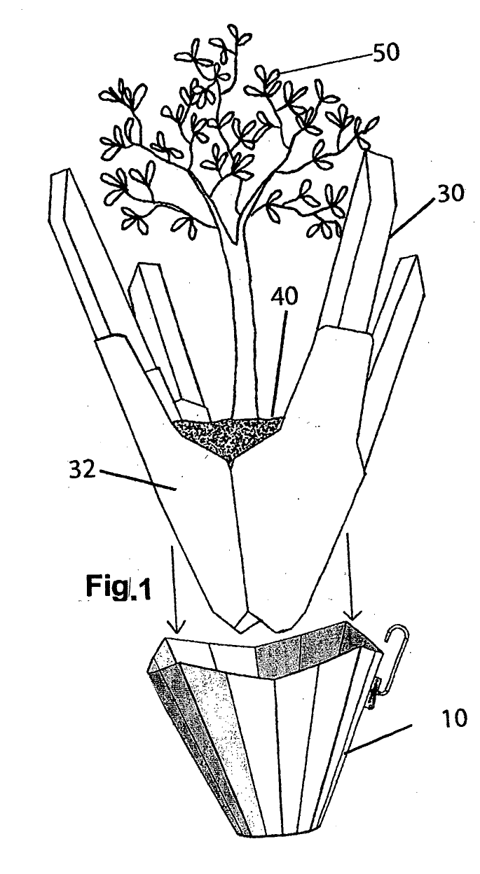

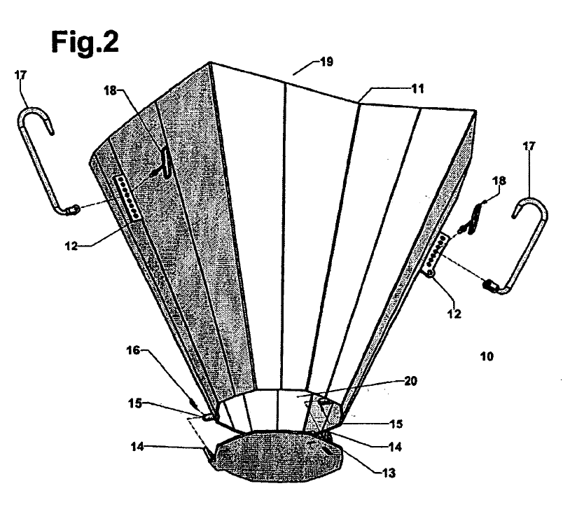

### DETAILED DESCRIPTION—FIGS. 1 AND 2

FIG. 1 of the drawings shows an apparatus 10 according to the present invention for moving trees and the like. In the drawings, like reference numbers, designate like or corresponding parts throughout the figures shown. The apparatus 10 is fabricated from inorganic materials and has an interior surface which is conforms to the extended blades 32 of a typical truncated open-bottom tree spade 30. The retainer shell 11 is of the construction shown in FIG. 2 where a large retainer top opening 19 is at the end opposite of a smaller retainer bottom opening 20. The retainer shell 11 is of suitable shape to fit snugly over the extended blades 32 of a tree spade 30. The retainer shell 11 is constructed to receive the root ball 40 of a transplant 50 with the bottom of the root ball 40 ending at the retainer bottom opening 20. The upper portions of a root ball 40 project out of the retainer top opening 19. The bottom opening 20 is normally closed by the bottom lid 13 during transport and is normally open to remove residual soil after use.

Coupling the apparatus 10 to the tree spade 30 as shown in FIG. 1 is accomplished by placing the tree spade blades 32 into apparatus 10. The couplers 17 shown in FIG. 2 connect the retainer 11 directly to the tree spade. The couplers 17 are attached to lift tabs 12 and held in place with pins 18. The apparatus 10 is designed to be transported by tree spade 30 once the pins 18 are secured.

Uncoupling the apparatus 10 from the tree spade 30 is accomplished by setting the apparatus 10 down on the ground with the tree spade 30. With the weight of the apparatus 10 on the ground, the pins 18 and the couplers 17 are removed. Once the couplers 17 are removed, the tree spade blades 32 can be lifted out of the retainer 11.

The bottom lid 13 slides completely on and off to open up the retainer bottom opening 20. Bottom guides 14 attached to the bottom lid 13 slide on guide pegs 15 attached to the retainer 11. The bottom lid 13 is secured in the on position with a guide peg safety clip 16 placed through a correspondingly sized hole in the outer guide peg 15. The bottom lid 13 comprises an important feature of the present invention; the bottom lid 13 will prevent any soil from escaping out of the open-bottom of a truncated tree spade 30. Additionally, since the bottom lid 13 is removable and the retainer 11 portable, it allows one to dump residual soil in a desired location.

Referring to FIG. 1 it will thus be appreciated that the apparatus 10 being attached to the tree spade 30 allows a root-ball 40 to be transported in an open-bottom tree spade 30 without spilling soil.

Conclusion, Ramifications, and Scope

The reader will see that the tree spade soil retainer allows one to dig and transport loose soils with a truncated open-bottom tree spade in locations that previously where impractical or not accessible. Additionally, it can be used easily and conveniently to transport root-balls and soil plugs across a home owner's lot, field, or to a nearby trailer without fear of spilling soil. Other than the soil retainer itself, added to a tree spade, no additional equipment is needed. The soil retainer extends the range of use of a truncated open-bottom tree spade while decreasing shock and mortality to transplants.

Although the detailed description above contains many specificities, these should not be construed as limiting the scope of the tree spade soil retainer. The description is merely providing illustrations of some of the presently preferred embodiments. For example, the bottom lid may take a different shape or may be hinged, clamped, bolted or pinned into position. Also, the couplers need not be hooks connected to lift tabs as shown in FIG. 1 and FIG. 2. Coupling may take place through a variation of devices. While I believe I have described the preferred embodiment of the couplers, an alternative embodiment would be couplers designed into the tree spade itself. Thus, the scope of the soil retainer should be determined by the appended claims and their legal equivalents, rather than by the examples given.

I claim:

1. An apparatus, comprising: a cone shaped retainer shell of conforming shape to accommodate the extended blades of a tree spade; a bottom lid; coupling means for connecting said retainer shell to a tree spade for transport; and providing a portable container for root-balls and soil to stay collectively bound together during transport thereby increasing the survivability of a transplant and the efficiency of a tree spade method.

2. The apparatus of claim 1, wherein said retainer shell is constructed substantially of inorganic material.

3. The apparatus of claim 1, wherein said retainer shell is hollow with an open top, gradually converging downward with a smaller opening at the bottom, relatively conically prismatic in form.

4. The apparatus of claim 1, wherein said means for connecting said retainer shell to a tree spade comprises of a plurality of couplers respectively to a plurality of lift-tabs on the retainer shell.

5. The apparatus of claim 1, wherein said coupling connects the retainer shell to a tree spade by providing a direct means of attachment.

6. The apparatus of claim 1, wherein one member of the coupling includes a plurality of apertures, as a means for adjustment of said coupler.

7. The apparatus of claim 1, wherein said bottom lid includes a plurality of guides to slidably join said bottom lid to the underside of the retainer shell.

8. An apparatus, comprising: a cone shaped retainer shell of conforming shape to accommodate the extended blades of a tree spade; coupling means for connecting said retainer shell to a tree spade for transport and providing a portable container for root-balls and soil to stay collectively bound together thereby increasing the survivability of a transplant and the efficiency of a tree spade method.

9. The apparatus of claim 8, wherein said retainer shell is constructed substantially of inorganic material.

10. The apparatus of claim 8, wherein said retainer shell is hollow with an open top, gradually converging downward with a smaller opening at the bottom, relatively conical in form.

11. The apparatus of claim 8, wherein said coupling respectively connects the retainer shell to a tree spade by providing a method of attachment.

12. The apparatus of claim 8, wherein said means for coupling said retainer shell to a tree spade comprises of a plurality of couplers spaced respectively between the retainer shell and the tree spade.

13. The apparatus of claim 8, wherein one member of the coupling includes a plurality of apertures, as a means for adjustment of said coupler.

14. A method utilizing a cone shaped retainer shell of conforming shape to accommodate the extended blades of a tree spade; a bottom lid; coupling means for connecting said retainer shell to a tree spade for transport; providing a way for root-balls and soil to stay collectively bound together whereby increasing the survivability of a transplant and the proficiency of a tree spade.

15. The method of claim 14, utilizing a retainer shell that is physically shaped like the extended-blades of a tree spade providing a method of containment and transport that is dependent upon gravity whereby said containment is controllable.

16. The method of claim 14, wherein said retainer shell is constructed substantially of inorganic material whereby providing adequate support for the transplant.

17. The method of claim 14, wherein said retainer shell is hollow with an open top, gradually converging downward with a smaller opening at the bottom, relatively conical in form providing proper fit for a root-ball whereby said root-ball continues to hold its form.

18. The method of claim 14, wherein said coupling respectively connects the retainer shell to a tree spade by providing a method of attachment whereby an operator can quickly connect and disconnect the retainer shell.

19. The method of claim 14, wherein one member of the coupling utilizes a plurality of apertures, providing a means for adjustment of said coupler thereby closely confining the root-ball in the shell of the retainer.

20. The method of claim 14, wherein said bottom lid is contiguous with the underside of the retainer shell providing a means to empty said retainer shell whereby an operator can easily dispose of residual soil at a desired location.
